(19) United States
(12) Patent Application Publication
(10) Pub. No.: US 2013/0327067 A1
(43) Pub. Date: Dec. 12, 2013

(54) METHOD FOR EFFICIENTLY DELIVERING LIQUID ARGON TO A FURNACE BY RE-CONDENSATION IN A PHASE SEPARATOR

(71) Applicants: Rozalia Papp, Orland Park, IL (US); David C. Braithwaite, Houston, TX (US); Richard Sauer, Hinsdale, IL (US); John Buonassisi, Downers Grove, IL (US)

(72) Inventors: Rozalia Papp, Orland Park, IL (US); David C. Braithwaite, Houston, TX (US); Richard Sauer, Hinsdale, IL (US); John Buonassisi, Downers Grove, IL (US)

(73) Assignee: Air Liquide Industrial U.S. LP, Houston, TX (US)

(21) Appl. No.: 13/492,564

(22) Filed: Jun. 8, 2012

(51) Int. Cl. F17C 9/02; F25D 17/02

(52) U.S. Cl. 62/50.5; 62/64

(57) ABSTRACT

A method of improving the efficiency in delivery of a cryogenic liquid to the surface of a metal body in a furnace, the method comprising the steps of delivering a liquid cryogen (10, 20) to a liquid-gas phase separator (30), allowing a gaseous cryogen (45) present in a liquid phase (40) of the liquid cryogen to separate from the liquid cryogen (40), condensing (60, 70, 80) the gaseous cryogen (45) to an additional amount of liquid cryogen (40), delivering the liquid cryogen and the additional amount of liquid cryogen (50) to the surface of a metal body in a furnace.

### TECHNICAL FIELD

The invention relates to the application of Liquid Argon for inerting the atmosphere above a metal body in a furnace.

### BACKGROUND ART

Many metals react to water and/or oxygen in air which intensifies when the metal is melted. There exist a variety of techniques to reduce the level or these air constituents sufficiently. A widely used technique is commercially named SPAL™. The SPAL™ process involves pouring liquid cryogens over the metal to create a continuous covering. As this liquid vaporizes, the surface of the metal is protected from oxygen and water in the air. One continuing issue with SPAL™ is the loss of liquid cryogen prior to pouring on the metal surface. Delivery systems have been optimized with e.g. vacuum jacketed insulation to minimized vaporization in the piping. Most SPAL™ systems still have enough vapor formation within the delivery system to require terminal phase separators. The vapor from such phase separators is generally vented to the atmosphere. In certain advanced SPAL™ systems, the vapor is directed onto the metal surface to augment the inerting by the liquid covering. While these advanced SPAL™ systems make use of the loss vapor from the liquid cryogen, the inerting value of this vapor is not as high that derived by an equal amount of liquid cryogen poured onto the metal. Consequently, it would be useful in many instances if vaporization losses in SPAL™ systems could be further reduced. From a cost analysis perspective, reduction of losses to vaporization will have the most impact when liquid Argon is the inerting liquid cryogen.

### DISCLOSURE OF INVENTION

The invention primarily addresses the losses of liquid Argon in a foundry or other metallurgy facilities utilizing a SPAL™ system to provide protection of metals in furnaces from atmospheric exposure. The basic technique to improve liquid Argon utilization efficiency (or possibly use of other cryogenic liquids or mixture) is the sub-cooling of Argon from a liquid Argon bulk source tank. The Argon is ideally sub-cooled as close to the point of dispensation onto the metals as is practical. The sub-cooling should be sufficient to either a) compensate for subsequent in transit heating to reduce the amount of liquid Argon that becomes vaporized prior to dispensation onto the metal or b) condense a portion of Argon vapor that evolves from the liquid Argon due to prior in transit heating and/or pressure reduction between the tank and the SPAL™ piping system, or both (“target temperature”).

Bulk storage tanks are often pressurized while most SPAL™ piping and delivery systems are not pressurized. The depressurization of bulk tank liquid Argon causes a significant amount of liquid Argon from the bulk tank to vaporize upon depressurization. An intervening sub-cooling step can be adapted to condense some or even most of the gaseous Argon back to liquid Argon while also sub-cooling the liquid Argon to the target temperature.

Finally, the sub-cooling of liquid Argon will reduce the amount of Argon gas in the SPAL™ piping and delivery systems. This will provide an added benefit of reduced flow rate variation and sputtering of liquid Argon from a dispensing lance due to gas build up in the pipes.

Target Temperature

The target temperature will vary depending on the specific facility SPAL™ system. For example, foam insulated pipes will generate more gaseous Argon than vacuum insulated pipes. The piping distance from the point of sub-cooling to the dispensing lance will affect the degree of transit associated heat gain and thus the quantity of liquid Argon that is vaporized en route. Other facility specific factors will impact the target temperature.

In addition to facility specific factors, the target temperature for liquid Argon sub-cooling is governed in part by physical limitations. Argon freezes at −189 degrees C. Thus, −189 degrees C. constitutes a lowest end target temperature for making a liquid/solid slush. A liquid/solid slush would need to be sufficiently composed of liquid Argon to flow in the SPAL™ piping. The solid Argon mixed in with the liquid would contribute more heat absorption capacity for the mixture due to the heat required to melt the solid. Forming Argon slush is not required for the invention to operate. For example, this maximum level of sub-cooling will not be of sufficient benefit in terms of Argon vaporization mitigation to justify the energy consumption required. In addition, from a process control perspective, forming consistently flowing liquid/solid slush will be quite difficult. Over-freezing will block the piping and stop flow. Thus, highly preferably the target temperature will be sufficiently above the freezing point to avoid formation of any solid Argon.

The upper end of the target temperature range will be governed in part by the applicable boiling point which in turn depends in part on the pressure. Liquid Argon in bulk storage tanks is generally maintained under pressure (for delivery of liquid Argon from the bulk tank) and at a temperature below the boiling point at the bulk tank pressure. An example from current commercial systems, Liquid Argon may be maintained in bulk tanks at 45±2 psig (310.26 kPa) and −176 degrees C. The pressure in the SPAL™ system will generally be atmospheric to e.g. 22±2 psig (253±115.11 kPa). This means liquid Argon will equilibrate by vaporization-cooling until the temperature of the remaining liquid reaches the boiling point temperature at the lower pressure (at atmospheric pressure, roughly −185.7 degrees C.). Thus, for example, the target temperature for sub-cooling in a pressurized system component could be different than in an atmospheric pressure component of the same system.

Sub-Cooling Location

In principle, the liquid Argon in the bulk tank may be sub-cooled as the sole sub-cooling step, or in combination with a downstream sub-cooling step or series of sub-cooling steps. Preferably however, a single sub-cooling step is integrated into the SPAL™ system as close to the dispensing lance as is practical.

If a particular SPAL™ system has Argon losses primarily due to depressurization from the bulk tank to the SPAL™ system piping, the sub-cooling step may be carried out as close as possible to the bulk tank to also improve flow rate and flow consistency through the piping system which is negatively affected by the presence of large gas volumes.

Multiple sub-cooling steps may be used such as both close to the bulk tank and as close to the SPAL™ lance as possible.

Sub-Cooling Step Equipment

The liquid Argon sub-cooling and/or gaseous Argon condensation to liquid may be implemented by any suitable equipment. For example, liquid Argon in a bulk storage tank may be sub-cooled by the same refrigeration process and similar equipment as used in cryogenic distillation. Alternatively, liquid and gaseous Argon may be passed through a sub-cooling heat exchanger close to the dispensing lance. The refrigerant in the heat exchanger may for example be pressurized Argon gas from the headspace of the bulk storage tank. Alternatively, a separate source of another liquid cryogen such as liquid Nitrogen may be used. Heat from the Argon condensing and sub-cooling will be transferred to the liquid Nitrogen, resulting in Nitrogen vapor generation. The Nitrogen vapor may be vented to the atmosphere.

### BRIEF DESCRIPTION OF DRAWINGS

FIG. 1 shows a schematic of an embodiment of the invention with a phase separator and an internal integral condensation coil.

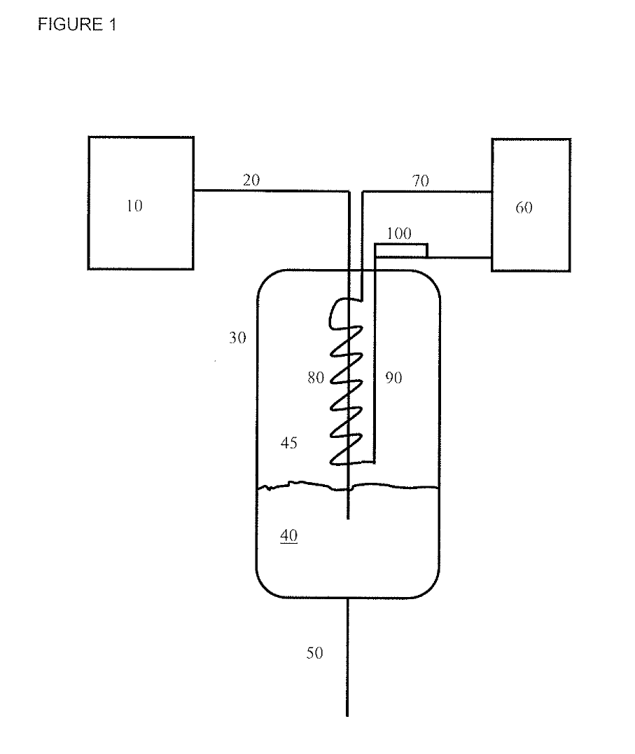

### SUMMARY OF THE INVENTION

The invention is described in part by the following numbered sentences:
1. A method of improving the efficiency in delivery of a cryogenic liquid to the surface of a metal body in a furnace, the method comprising the steps of:
a) Delivering a liquid cryogen (10, 20) to a liquid-gas phase separator (30),
b) Allowing a gaseous cryogen (45) present in a liquid phase (40) of the liquid cryogen to separate from the liquid cryogen (40),
c) Condensing (60, 70, 80) the gaseous cryogen (45) to an additional amount of liquid cryogen (40),
d) Delivering the liquid cryogen and the additional amount of liquid cryogen (50) to the surface of a metal body in a furnace.
2. The method of sentence 1, wherein the liquid cryogen (10) is at least 90% pure Argon such as industrial grade purity Argon.
3. The method of sentences 1-2 wherein the condensation step c) is performed by a heat exchange (80) with liquid Nitrogen (60, 70).
4. The method of sentences 1-3 wherein the heat exchange is performed by flowing the liquid Nitrogen (60, 70) through a heat exchange device (80) in thermal communication with the gaseous Argon within the phase separator.
5. The method of sentences 1-4 wherein the heat exchange device (80) is a condensation coil.
6. The method of sentences 1-5 wherein the condensation coil (80) is also in thermal communication with the liquid Argon (40) within the phase separator (30).
7. The method of sentences 1-5, wherein the liquid Nitrogen (80) is at a temperature between the freezing point and the boiling point of the liquid Argon (40), preferably within a ±2 degrees C. range around a half way between.
8. A phase separator apparatus for delivery of liquid cryogen to a body of metal in a furnace, the apparatus comprising:
   a) A chamber (30) adapted to retain and hold a volume of a liquid cryogen (40) and further adapted to permit the separation of a gaseous cryogen (45) from the liquid cryogen (40),
   b) An inlet (20),
   c) An outlet (50) configured to emit the liquid cryogen (40) to the surface of a metal body in a furnace such as through a lance configured to receive the liquid cryogen (40) and dispense the liquid cryogen (40) onto the metal body in the furnace,
   d) A heat exchange device (80, 90) within the chamber, the heat exchange device (80, 90) being capable of condensing the gaseous cryogen (45) into a liquid cryogen (40).
9. The apparatus of sentence 8, wherein the liquid cryogen (10, 40) is at least 90% pure Argon such as industrial grade purity Argon.
10. The apparatus of sentence 8 or 9, wherein the heat exchange device is a condensation coil (80) containing liquid Nitrogen (60, 70).
11. A method of improving the efficiency in delivery of a cryogenic liquid (10, 160) to the surface of a metal body in a furnace, the method comprising the steps of
   a) Causing a flow of the liquid cryogen
      i) from a source of the liquid cryogen (10),
      ii) to the surface of a metal body,
   b) Sub-cooling the liquid cryogen or a combination of the liquid cryogen and a cryogen gas (40) between step a), sub-step i) and step a), sub-step ii) to reduce a temperature of the liquid cryogen or the combination of the liquid cryogen and the cryogen gas.
12. The method of sentence 11 wherein the sub-cooling step b) comprises reducing the temperature to a target temperature that is a) below a boiling point of the liquid cryogen and b) above a freezing point of the liquid cryogen, preferably half way between the freezing and boiling points.
13. The method of sentence 11 or 12, further comprising a step of sub-cooling a cryogen gas vaporized from the liquid cryogen (45) to reduce a temperature of the vaporized cryogenic gas and thereby to re-condense a portion of the vaporized cryogen gas into an additional amount of the liquid cryogen (40).
14. The method of sentences 11-13, wherein the liquid cryogen (10) comprises Argon.
15. The method of sentence 14, wherein the Argon is at least 90% pure Argon.
16. The method of sentence 14, wherein the target temperature is lower than −170° C. and greater than a freezing point of the liquid cryogen (10).
17. The method of sentences 11-16 further comprising reducing the cryogen gas, the vaporized cryogen gas, or both (45) to a condensation target temperature that condenses at least 5% of the gas (45) into an additional amount of the liquid cryogen (40).
18. The method of sentence 17 wherein the amount of gas (45) condensed is from 5% to 95% of the starting amount of gas.
19. The method of sentence 17, wherein the amount of gas (45) condensed is from 25% to 75% of the starting amount of gas.
20. The method of sentence 17 wherein the condensation target temperature is less than −170 degrees C.
21. The method of sentence 20, wherein the condensation target temperature is from −185.5 degrees C. to −188.9 degrees C., preferably −187.2 degrees C.
22. The method of any of the preceding sentences 1-21 wherein the sub-cooling comprises two or more discrete sub-cooling steps.

### MODE(S) FOR CARRYING OUT THE INVENTION

Liquid Argon source 10 source is generally a bulk tank supplied with liquid Argon 40. The liquid Argon is transported by pipe 20 into phase separator 30 then out to a SPAL process generally by diffuser lance 50 with an optional auxiliary phase separator. Liquid Nitrogen source 60 is also generally a bulk tank supplied with liquid Nitrogen. Liquid Nitrogen is delivered by pipe 70 to condensing coil 80 and the liquid and vaporous Nitrogen returns via pipe 90 to liquid Nitrogen source 60. Venting phase separator 100 removes and expels vaporized Nitrogen from the pipe 90 prior to return of the recycled liquid Nitrogen. The liquid Nitrogen should be sufficiently cold to recondense vaporized Argon when passed through the condensation coil. Argon boils at −185.85° C. under standard atmospheric pressure whereas liquid Nitrogen boils at −195.79° C. Nitrogen also has a greater specific heat capacity than Argon. Thus liquid Nitrogen will under normal circumstances be able to recondense the vapor phase Argon in a liquid-vapor Argon phase separator.

The liquid Nitrogen temperature (and pressure) in coil 80 should be selected to provide sufficient cooling under operating condition to condense Argon vapor 45 without freezing it or the liquid Argon 40. The precise operating conditions will depend on the pressure and temperature of the Argon. An optimally balanced system will preferably cool the liquid Argon 40 (which may be in direct contact with cooling coil 80) to a target temperature half way in-between the boiling point and freezing point of the Argon. For example, at 31 psig (315.06 kPa) the boiling point of Argon is −173 degrees C. and the freezing point is −189 degrees C. The preferred target temperature for sub-cooling would thus be −181 degrees C. Because Argon has a narrow temperature range between boiling and freezing, target temperatures at e.g. −188 degrees C. run the risk of excessive Argon freezing due to variations in liquid Nitrogen temperature. By targeting a median temperature in the liquid phase range, the system will tolerate some downward temperature fluctuations in the liquid Nitrogen cooling system without overly sacrificing Argon gas condensation efficiency.

### PROPHETIC EXAMPLE 1

Prophetic example 1 relates to the mode for carrying out the invention shown in FIG. 2. If it is assumed that the liquid Argon is in equilibrium with the gas at a pressure of 190 psig (1411.33 kPa), the calculated temperature is 122.8 K (−238.6° F.; −150.3° C.). Considering liquid Argon in equilibrium with the gas at a pressure of 0 psig (101.33 kPa), the calculated temperature is 8T3 K (−302.5° F.; −185.7° C.). Because the bulk tank stores liquid Argon at a temperature higher than the normal boiling point, when the pressure is removed, some of the Argon will vaporize, cooling the remaining Argon until the temperature is 87.3 K (−302.5° F.; −185.7° C.). In an adiabatic case, Equation 1 would apply:

H_{sat'd. liq}^{190 psig}=(1−x)*H_{sat'd. liq}^{0 psig}+xH_{sat'd. vap}^{0 psig}=H_{sat'd. liq}^{0 psig}+sΔHᵥₐₚ^{0 psig}
Equation 1—Result of adiabatic expansion of liquid Argon.

Based on this equation, 26.6% of the liquid Argon would vaporize upon depressurization to decrease the temperature of the remaining Argon. By sub-cooling all of the Argon to 110.2 K (−261.4° F.; −163° C.) by heat exchange with 200 psig (1480.27 kPa) liquid Nitrogen, the fraction of Argon vapor will decrease to 17.6%. If the pressure of the liquid Nitrogen is decreased from 200 to 60 psig (515 kPa) to decrease the liquid Nitrogen temperature prior to sub-cooling the liquid Argon, the temperature of the sub-cooled Argon will be decreased by heat exchange to 94.4 K (−289.8° F.; −178.78° C.). At this temperature, only 6.4% of the Argon will be in the gas phase.

### INDUSTRIAL APPLICABILITY

The present invention is at least industrially applicable to the protection of metals in foundry furnaces from air.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, language referring to order, such as first and second, should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method of improving the efficiency in delivery of a cryogenic liquid to the surface of a metal body in a furnace, the method comprising the steps of:
a) delivering a liquid cryogen (10, 20) to a liquid-gas phase separator (30),
b) allowing a gaseous cryogen (45) present in a liquid phase (40) of the liquid cryogen to separate from the liquid cryogen (40),
c) condensing (60, 70, 80) the gaseous cryogen (45) to an additional amount of liquid cryogen (40),
d) delivering the liquid cryogen and the additional amount of liquid cryogen (50) to the surface of a metal body in a furnace.

2. The method of claim 1, wherein the liquid cryogen (10) is at least 90% pure Argon such as industrial grade purity Argon.

3. The method of claim 1, wherein the condensation step c) is performed by a heat exchange (80) with liquid Nitrogen (60, 70).

4. The method of claim 1, wherein the heat exchange is performed by flowing the liquid Nitrogen (60, 70) through a heat exchange device (80) in thermal communication with the gaseous Argon within the phase separator.

5. The method of claim 1, wherein the heat exchange device (80) is a condensation coil.

6. The method of claim 1, wherein the condensation coil (80) is also in thermal communication with the liquid Argon (40) within the phase separator (30).

7. The method of claim 1, wherein the liquid Nitrogen (80) is at a temperature between the freezing point and the boiling point of the liquid Argon (40).

8. The method of claim 1, wherein the liquid Nitrogen (80) is at a temperature within a ±2 degrees C. range around the temperature half way between the freezing point and the boiling point of the liquid Argon (40).

9. A phase separator apparatus for delivery of liquid cryogen to a body of metal in a furnace, the apparatus comprising:
a) a chamber (30) adapted to retain and hold a volume of a liquid cryogen (40) and further adapted to permit the separation of a gaseous cryogen (45) from the liquid cryogen (40),
b) an inlet (20),
c) an outlet (50) configured to emit the liquid cryogen (40) to the surface of a metal body in a furnace,
d) a heat exchange device (80, 90) within the chamber, the heat exchange device (80, 90) being capable of condensing the gaseous cryogen (45) into a liquid cryogen (40).

10. The apparatus of claim 9, wherein the liquid cryogen (10, 40) is at least 90% pure Argon such as industrial grade purity Argon.

11. The apparatus of claim 9, wherein the heat exchange device is a condensation coil (80) containing liquid Nitrogen (60, 70).
